(19) United States
(12) Patent Application Publication
(10) Pub. No.: US 2006/0085389 A1
(43) Pub. Date: Apr. 20, 2006

(54) Method for transformation of regular expressions

(75) Inventors: Michael Flanagan, Newtown (AU); Darren Williams, Newtown (AU); Stephen Gould, Killara (AU); Robert Matthew Barrie, Double Bay (AU); Teewoon Tan, Roseville (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/213,622

(22) Filed: Aug. 26, 2005

Related U.S. Application Data
(60) Provisional application No. 60/604,983, filed on Aug. 26, 2004.

(51) Int. Cl. G06F 17/30; G06F 7/00

(52) U.S. Cl. 707/2; 707/5; 707/101

(57) ABSTRACT

A method and apparatus for transforming regular expressions into a less resource intensive representation is disclosed. The method and apparatus converts a collection of regular expressions into a multi-level representation in which the memory requirements of the lowest level representation is reduced when compared with a conventional finite state automaton representation. The method and apparatus converts a collection of regular expressions into a collection of segments and a higher level representation in a way that retains the semantics of the original set of regular expressions. This transformation is performed through the use of an intermediate form. The resulting representation and collection admit an implementation which avoids the potentially costly memory requirements of a traditional implementation of the original expressions.

### CROSS-REFERENCES TO RELATED APPLICATIONS

The present application claims benefit under 35 USC 119(e) of U.S. provisional application No. 60/604983, filed on Aug. 26, 2004, entitled “Method For Transformation Of Regular Expressions” the content of which is incorporated herein by reference in its entirety.

### BACKGROUND OF THE INVENTION

The need to perform sophisticated, high performance searching of data is driven by the desire for high performance quality-of-service (QoS) and signature-based security systems. Such security systems include intrusion detection, virus scanning, content classification, network surveillance, spam filtering, etc. The sophisticated requirements of these searching domains make the use of simple literal textual searching inadequate. A common paradigm that is used in these search domains is that of regular expression searching.

Regular expressions are patterns built up by combining literal text with special operators. These operators are textual characters that have been deemed to convey special meaning. Minimal regular expression syntax comprises literal text combined with the following operators, as shown in table I below

TABLE I

| Operator | |
|---|---|
| Characters(s) | Meaning |
| \| | Disjunction operator, used to match one of two |
| | expressions; e.g. a\|b would match a or b |
| * | Repetition operator; used to match zero or more |
| | occurrences of an expression; e.g. a* would match zero |
| | or more occurrences of a |
| ( ) | Grouping operators that affect the scope of other |
| | operators; e.g. (a\|b)c would match ab or bc whereas |
| | a\|bc would match a or bc. |

This minimal expression syntax is frequently extended with the following standard operators shown in Table II below:

| Operator | |
|---|---|
| Characters(s) | Meaning |
| ? | Optional operator; used to match zero or one occurrence |
| | of an expression; e.g. ab? would match a or ab |
| + | Operator used to match one or more occurrences of an |
| | expression; e.g. ab+ would match a or ab or abb etc. |
| {n, m} | Bounded repetition operator; used to match between n |
| | and m occurrences of an expression, where n and m are |
| | non-negative numbers with m greater than or equal to n. |

Regular expressions are patterns against which an input stream may succeed or fail to match. Thus, they may be used as the basis of sophisticated searching systems. The conventional regular expression syntax can be extended to include the concept of action tags. Action tags are a postfix notation used to associate a number with a place in a regular expression. The semantics of actions is that when the regular expression, implemented in a suitable pattern matching architecture, matches up to the tagged point, the action tag is generated as an event. The following regular expression: 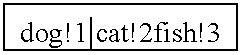
generates the event 1 when “dog” is matched, the event 2 when “cat” is matched and the events 2 and 3 on the input string “catfish”. Regular expressions using this extended syntax are referred to as “action tagged” regular expressions.

High throughput searching systems that use regular expressions rely on a high speed implementation of regular expression matching. The most common method for implementing high speed regular expression matching is use of Finite State Automaton representation.

FIG. 9 depicts two possible representations of a regular expression [201] as Finite State Automata. The second representation [203] is in the form of a Deterministic Finite State automaton (DFA). This DFA is depicted as a directed graph comprising a set of labeled nodes—some of which are terminal nodes, denoted with doubled circles—connected by directed edges that are labeled with symbols appearing in the regular expression. A single node, possessing an unlabeled inbound edge, is the initial node. The depiction of the DFA represents an abstract machine that is capable of processing a stream of input symbols and determining if the stream matches the corresponding regular expression [201]. The abstract machine is referred to as Deterministic because for each node there is never more than one emerging edge labeled with the same symbol. The first representation [202] depicts another abstract machine that embodies the regular expression [201] without the condition that applies to emerging edges in a deterministic automaton. This automaton [201] is known as a Non-deterministic Finite State Automaton (NFA). These two forms of Finite State Automata are well known to those trained in the art.

A Finite State Automaton (FSA) [see FIG. 9] is an abstract concept of a matching machine that can be realized as a very time-efficient implementation in computer software or hardware. The abstract concept comprises an alphabet of symbols; a set of states, one of which is marked initial and zero or more of which are marked “final”; and a transition function specifying a new state given a symbol and a current state. The automaton is “run” by consuming input symbols and using the transition function to work out the new value for the “current state” from the current value and the value of the input symbol. If, through this procedure, the automaton reaches a state that is marked “final”, the automaton is deemed to have matched the input.

Finite state automata come in two forms: Deterministic and Non-deterministic. If the transition function gives a single new state for any given current state and current symbol, the automaton is said to be a Deterministic Finite State Automaton (a DFA) [see FIG. 9]. When a DFA is searching an input stream it has a single current state. A DFA may be trivially implemented in hardware or software in such a way that the work needed to process each input symbol is always constant.

A finite state automaton with a transition function that generates more than one “next state” for some current state, current symbol combination, is said to be a Non-deterministic Finite State Automaton (an NFA) [see FIG. 9]. When processing an input stream, an NFA has a set of “current states”.

FIG. 8 depicts the process of converting a regular expression to a Deterministic Finite State Automaton. The regular expression [501] is converted, through a process—well understood by those skilled in the art—known as parsing; into a structured tree representation of the expression [502]. This structured representation is converted by one of several algorithms, also well documented in the literature, into a table representation of a Deterministic Finite State Automaton (DFA) [503]. This table has rows labeled with DFA state identifiers and columns labeled with input symbols. For any given row, labeled with some current state c, the column labeled with symbol s holds the state identifier d that is the destination state reached from an edge of the DFA that emerges from state c labeled with symbol s.

A regular expression may be converted into a DFA or an NFA through the use of an appropriate algorithm (see FIG. 8). The algorithm first converts the regular expression from a textual form into a structured form, then converts this structured form to an appropriate representation of a DFA or NFA using one of several techniques well documented in the literature [REFS]. The initial conversion from a textual from into a structured form is referred to as “parsing” the regular expression.

The excessive processing requirements of high performance searching systems demands the need for specialized hardware or software solutions. General software solutions, run on conventional hardware using a general purpose operating system, are unable to maintain the high throughput and constancy of throughput that is required of solutions in such domains.

In order to satisfy the constant throughput requirements of high performance searching it is necessary to build a system with a worst case performance that exceeds the required throughput or to build a system based on constant throughput algorithms and data structures. As the amount of data over which searches must be performed is growing faster than the rate of increase in processing power [ref], the provision of reasonable cost systems that can guarantee sufficiently high worst case performance is impractical. Development of practical high speed constant throughput devices is thus dependant on the use of constant throughput algorithms and data structures. The use of searching algorithms based on DFAs provides one solution.

Deterministic Finite State Automata use large amounts of memory to represent the required action for every possible situation that can arise during data searching. This is conventionally represented by a transition table giving, for each state, the appropriate next state for each possible input symbol. By explicitly representing the required action for every possible situation it is possible to keep the processing time to decide each such action to a constant. However, the large memory requirements of DFA based searching systems makes their use prohibitively expensive in many searching domains. In particular, for certain regular expressions, such as those of the form:

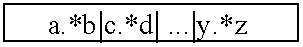

It is known to those skilled in the art, that a DFA representation will require a number of states that is exponential in the length of the expression. This implies that simply increasing the available memory will never be a sufficient solution. What is required is a system that preserves as much as possible of the constant throughput benefit of DFA based searching while reducing the overhead of the associated large memory requirements.

### BRIEF SUMMARY OF THE INVENTION

In accordance with the present invention, an apparatus and a method is provided to produce, from a regular expression, a configuration of a multi-level system while significantly reducing the overall memory requirements and, in particular, reducing the memory requirements of the lowest level DFA based layer of the generated multi-level system.

### BRIEF DESCRIPTION OF THE DRAWINGS

FIG. 1 is a flowchart of steps carried out to transform a regular expression, in accordance with one exemplary embodiment of the present invention.

FIG. 2 shows a regular expression transformed into a number of representations and collections, in accordance with one exemplary embodiment of the present invention.

FIG. 3 shows a regular expression transformed into a number of segments and a representation, in accordance with one exemplary embodiment of the present invention.

FIG. 4 shows a representation and a collection that together define an expression, in accordance with one exemplary embodiment of the present invention.

FIG. 5 shows a representation and a collection that together define an expression, in accordance with another exemplary embodiment of the present invention.

FIG. 6 shows a representation and a collection that together define an expression, in accordance with another exemplary embodiment of the present invention.

FIG. 7 shows a representation and a collection that together define an expression, in accordance with another exemplary embodiment of the present invention.

FIG. 8 is a simplified process of converting a regular expression to a deterministic finite state automaton, as known in the prior art.

FIG. 9 shows two possible representations of a regular expression as finite state automata, as known in the prior art.

FIG. 10A shows an automaton, as known in the prior art.

FIG. 10B shows an automaton, and an action tagged regular expression, in accordance with one exemplary embodiment of the present invention.

FIG. 11 shows an action tagged regular expression converted into two attributed finite state automata, in accordance with one embodiment of the present invention.

FIG. 12 shows a regular expression analyzed with respect to a table of patterns that are used to identify split candidates, in accordance with one embodiment of the present invention.

### DETAILED DESCRIPTION OF THE INVENTION

This invention relates to the automated transformation of regular expressions. In accordance with the present invention, a plurality of regular expressions is transformed into a second form—that includes a representation and collection of segments—whereby the language embodied by the second form is an approximation of the language embodied in the original plurality of expressions.

The method of the invention derives the second form, mentioned above, by deriving a first form, dividing this first form into a first collection of segments and producing a first representation that embodies relationships between the segments in the first collection. This first form is then transformed into the abovementioned second form.

Another object of the invention is to extract, from a plurality of regular expressions, features that can be efficiently represented as a Finite State Automaton (FSA) or a set of FSAs while maintaining a representation of higher order features of the regular expression to facilitate use in a multi-level pattern matching system.

Yet another object of the current invention is to facilitate the distribution of an implementation of a pattern matching system for regular expressions over multiple levels of a system; for example, a system comprising a software program supported by accelerated pattern matching hardware.

A further object of the invention is to generate a second form from a plurality of regular expressions, as described above, such that the collection of segments can be implemented in resource limited environments such as pattern matching acceleration hardware.

Another object of the invention is to translate a plurality of regular expressions into a second form, the overall space requirements of an implementation of which are less than those of a simple single level implementation of said regular expressions as a Finite State Automaton (FA). Various other objects of the present invention are apparent in view of the description provided below.

The invention described below is a method of transforming a plurality of regular expressions into a second form suitable for configuring one of a number of searching systems. Details of the invention are presented, describing its operation in generating configuration information for each of a variety of different searching apparatuses. In each such description the searching apparatus that is to be configured is referred to as the “destination apparatus” and is described along with the particular aspects of the method of the invention that are relevant to such an apparatus.

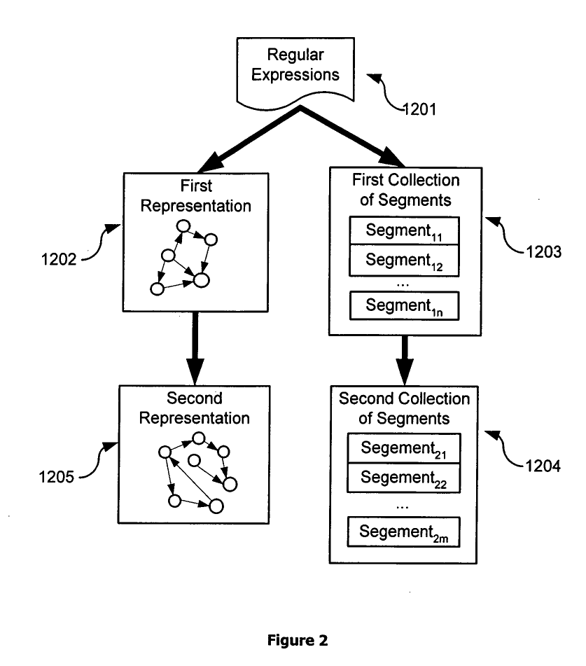

FIG. 2 shows the operation of the method of the invention. The invention transforms a plurality of regular expressions [1201] into a second form comprising a second representation [1205] and a second collection of segments [1204]. This is achieved through the intermediate step of converting the original expressions [1201] into a first form comprising a first representation [1202] and a first collection of segments [1203]. The generated Second Representation and Second Collection embody a semantics that approximates the semantics of the original input regular expressions. It is understood that various embodiments of the present invention may differ in terms of the Representations and Segments.

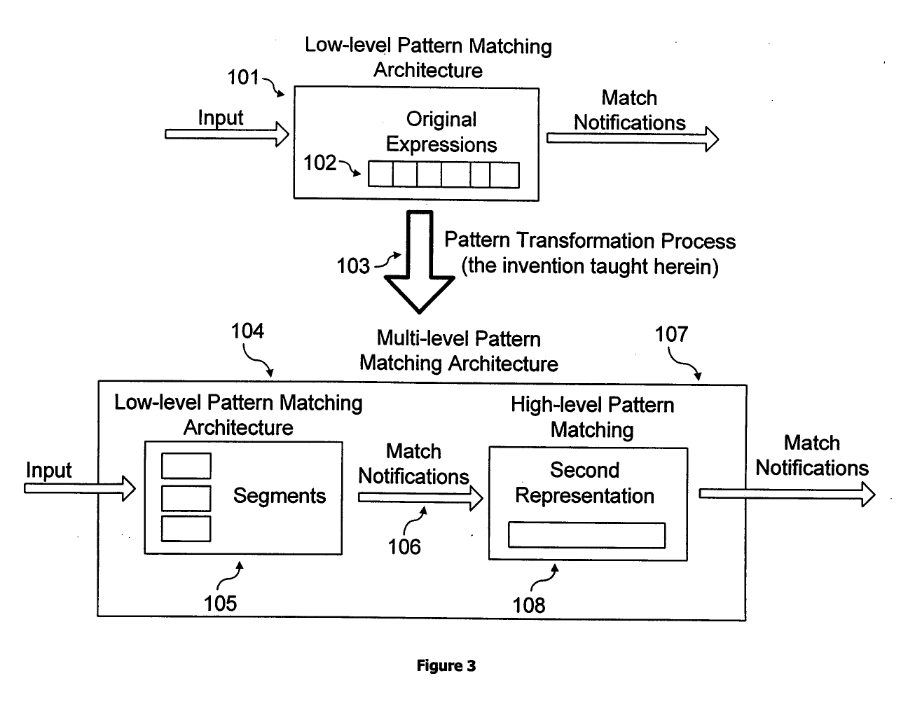

FIG. 3 is an abstract depiction of the operation of an embodiment of the invention showing the original plurality of regular expressions and the resultant segments and representation as they are used in a generic hierarchical pattern matching apparatus. The invention takes as input a plurality of regular expressions [102] and transforms it into a second form comprising segments [105] and a representation [108]. The input regular expressions [102] are conventional regular expressions designed to work with a standard single level pattern matching architecture [101], familiar to those skilled in the art. The regular expressions are modified by a Pattern Transformation Process [103] into a second form.

The second representation [108] generated by the method of the invention embodies some or all of the higher level semantic structure of the input regular expressions [102] that is lost in the segmentation process. This second form is derived in a form for use with a choice of high-level pattern matching architectures [107], or a hierarchy of progressively higher level pattern matching apparatuses.

The collection and representation comprising the second form derived by the method of the invention is used to configure a hierarchy of pattern matching architectures comprising at least two levels. The lowest level is any conventional single level pattern matching architecture of a style familiar to those skilled in the art. The higher levels comprise apparatuses selected from a variety of different types.

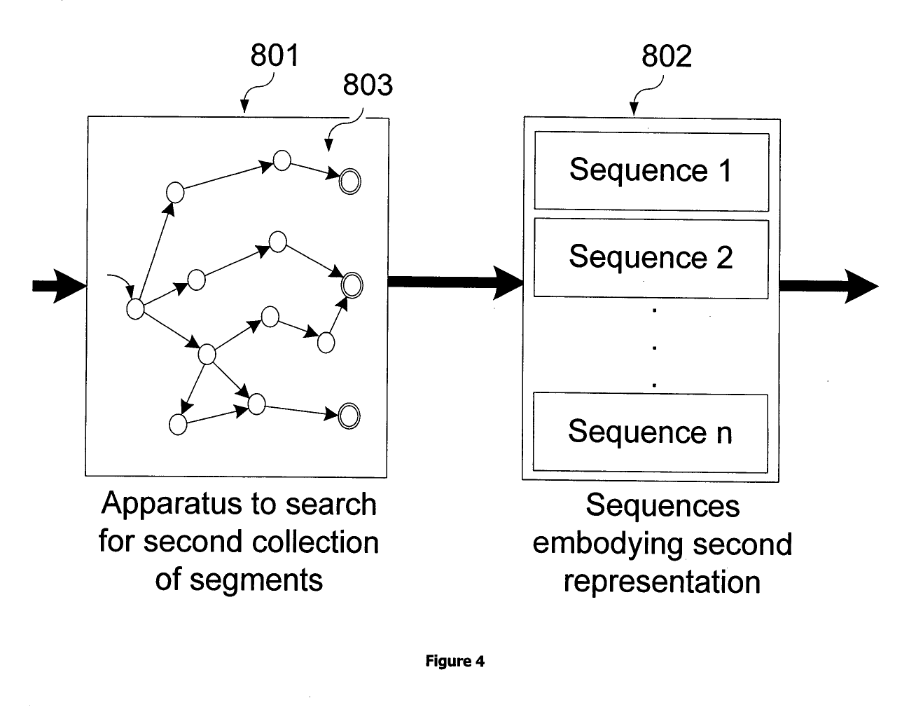

FIG. 4 depicts a destination apparatus configured using the second form generated by one embodiment of the invention. The configuration information is generated by the method of the invention when applied to an input plurality of regular expressions; it comprises: a collection of segments of the original plurality of expressions and a second representation in the form of a collection of sequences. The collection of sequences is compiled into a single finite state automaton [803] that is used to configure a low level searching apparatus [801]. The sequences comprising the second representation are used to configure a higher level searching apparatus [802]. In this embodiment of the invention the generated collection of segments are distinct substrings of the original regular expressions. These substrings are non-overlapping and occur sequentially in the original regular expressions. The generated sequences (the second representation) embody the sequential semantics of the segments with respect to the original regular expressions. This embodiment of sequential semantics allows the higher level matching apparatus [802] to match a language that is a superset of the language embodied in the original plurality of regular expressions.

In the destination apparatus depicted in FIG. 4, the generated segments have been used to generate a DFA [803]. This DFA is utilized by a searching apparatus [801] that simultaneously searches an input stream for occurrences of any strings of input symbols matching any of the generated regular expression segments. On matching any of the segments, the apparatus [801] generates a match event that is passed to a higher level apparatus [802], this match event comprising the unique identification tag that is assigned to the matched segment. The high level apparatus [802] simultaneously monitors the stream of events generated by the low level apparatus [801] for occurrences of any of sequences with which is has been configured. On matching any of the sequences with which it has been configured, the high level apparatus [802] generates an event visible to any extant external systems that may be utilizing the overall apparatus to perform searching.

Through the above described operational procedure the destination apparatus is able to perform pattern matching that is almost identical to matching using the original regular expression while requiring significantly less storage than would be required by a single level system that represented the input regular expression as a single DFA. The differences between the matching behavior of the presented apparatus, as configured by the method of the invention, and the matching behavior of an implementation of the input regular expression as a single DFA are recognizable by those skilled in the art as being insignificant in almost all domains in which such searching is performed. The breaking up of the original regular expression into a collection of segments reduces the possibility of exponential space requirements, well understood by those skilled in the art, that are typical of DFA representations of complex regular expressions.

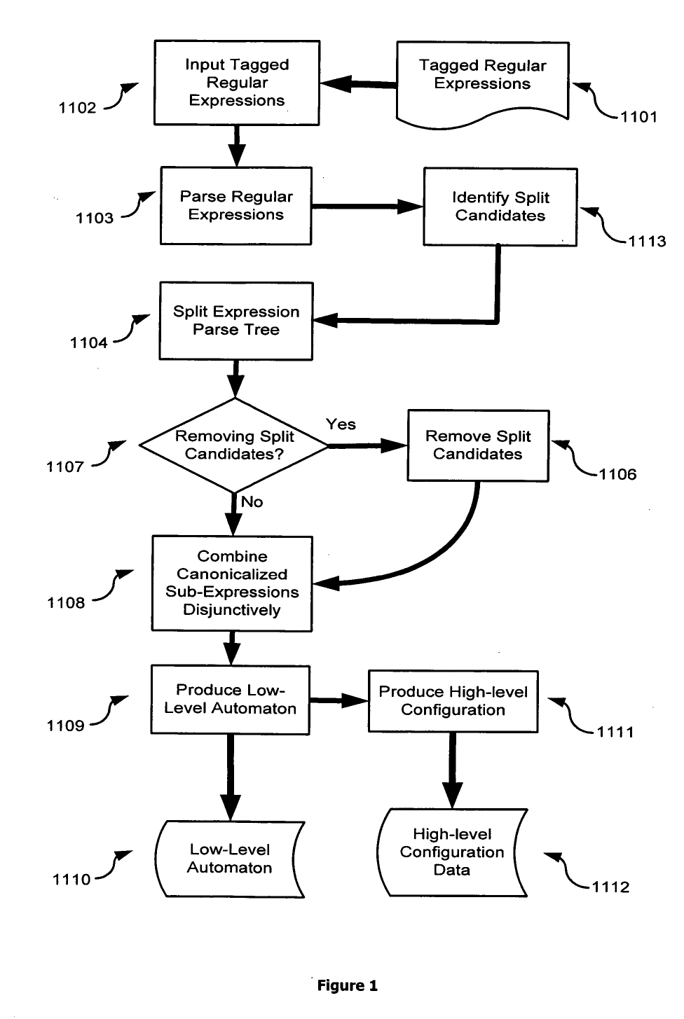

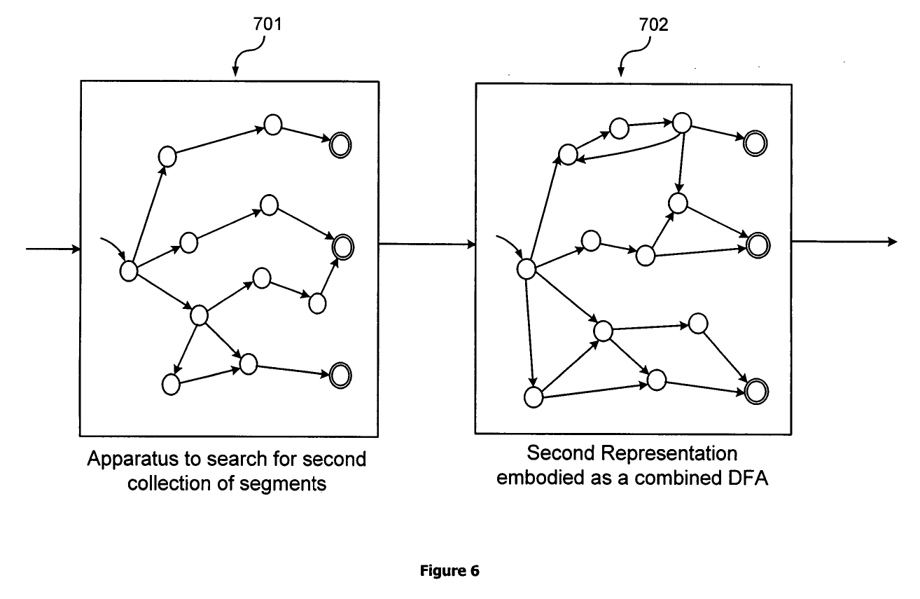

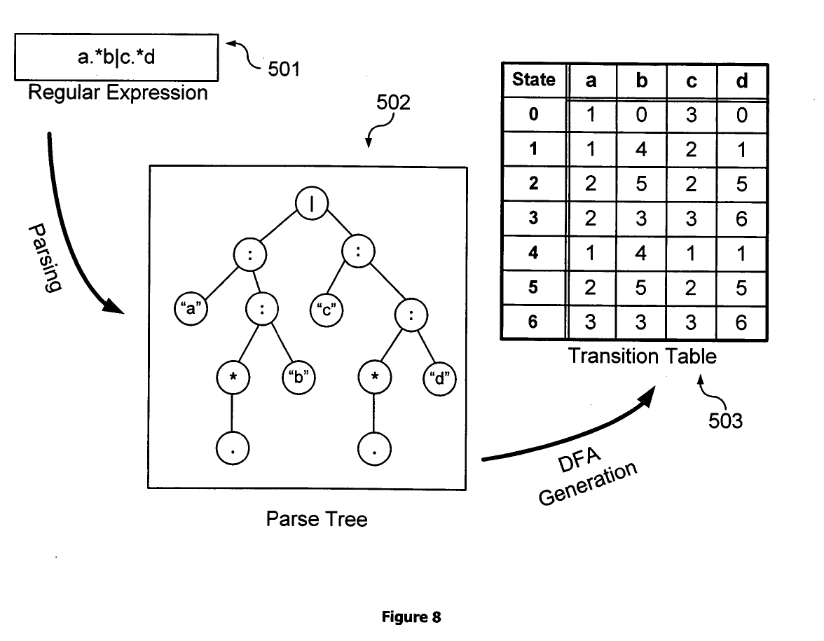

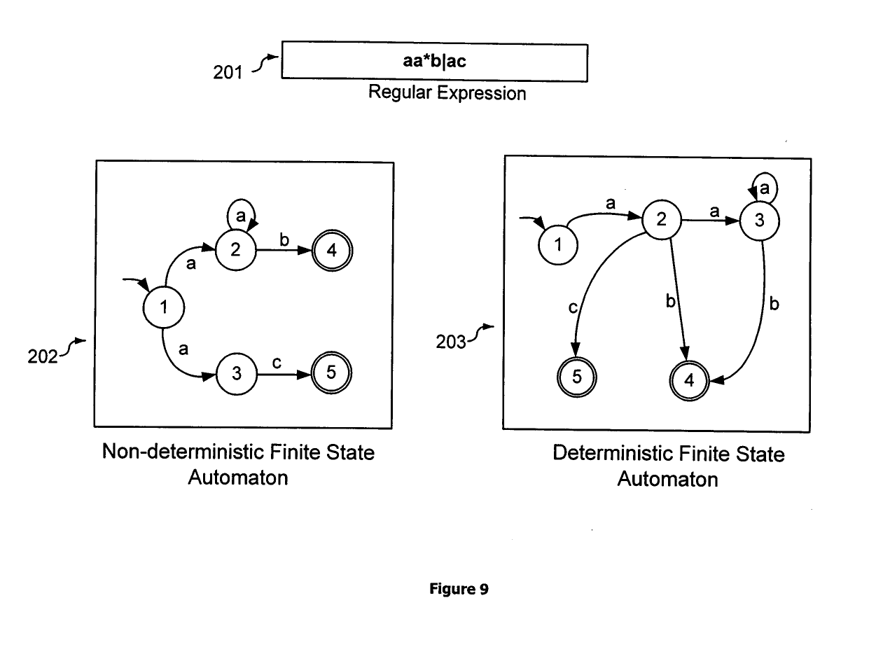

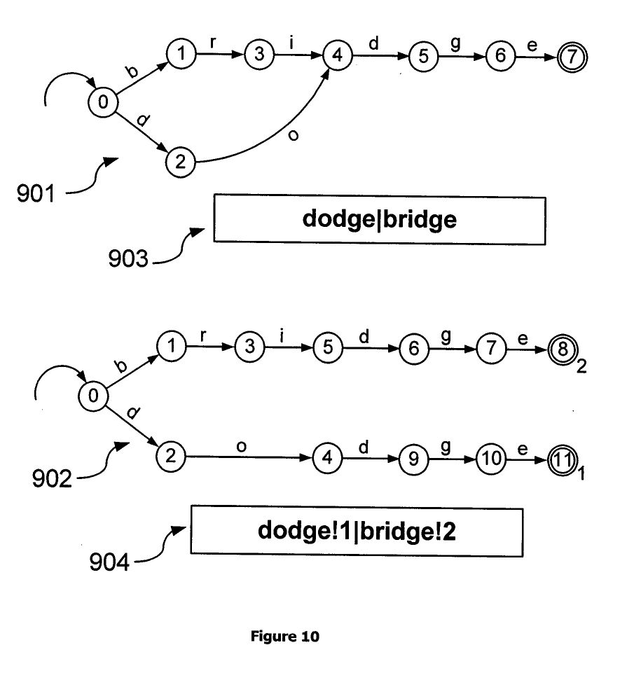

In another embodiment of the invention (see FIG. 6), tagged regular expressions are transformed for use with a secondary state machine, using the process depicted in the flow chart in FIG. 1. In this process a first plurality of regular expressions is parsed to form a parse tree representation, familiar to those skilled in the art (see FIG. 8). This parse tree is then analyzed for occurrences of “split candidates”; these are identified by analyzing sub-trees of the parse tree.

The split candidates are used in the segmentation process to produce a collection of sub-expressions of the first regular expression, e.g. the expression would be split at any occurrence of the sub-expression “.*” or “[ [symbol] \n]*”, either discarding or retaining the identified split candidates. The segmentation is performed by producing a canonical representation of any sub-expressions (sub-trees of the parse tree) resulting from the splitting process. These sub-expressions resulting from segmentation are each assigned a unique “tag”, then recombined disjunctively (using the “|” operator) to form a second regular expression.

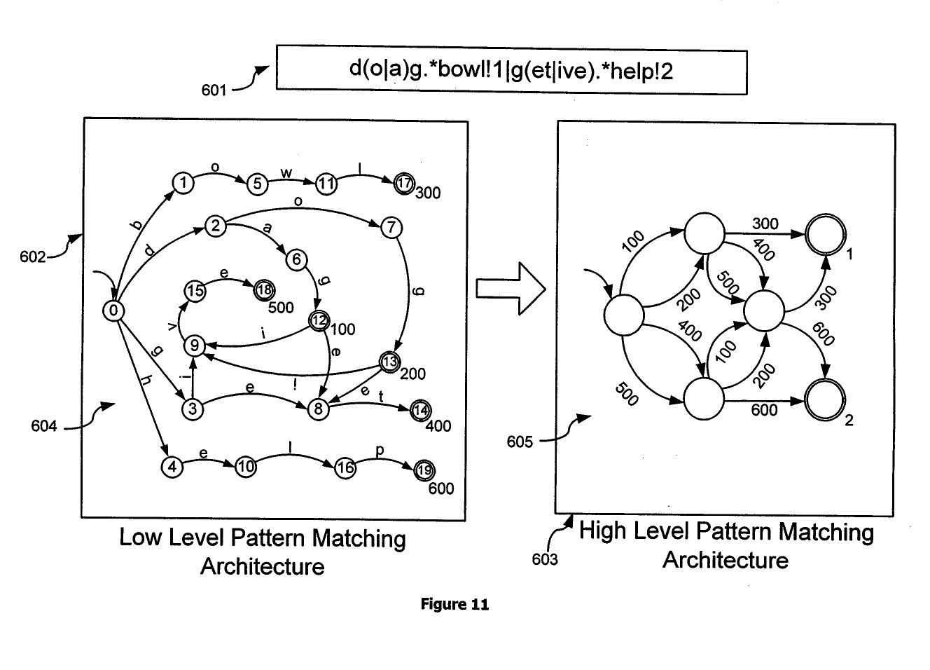

A second representation of the original regular expression is produced by replacing the sub-expression parse sub-trees (corresponding to the elements of the collection produced in abovementioned segmentation) with proxy nodes representing the unique tags previously assigned. The parse tree thus generated, is translated into a finite state automaton through conventional algorithms known to those skilled in the art, (see 605, FIG. 11) for which the input domain is the same as the set from which unique tags are selected in the recombination step.

The second regular expression generated in the recombination step is compiled, using extended algorithms, to a form for use on a hardware pattern matching device—this hardware pattern matching device generating the unique tags, assigned in the recombination step, in response to the matching any of the sub-expressions in the collection generated in the segmentation process (see 604, FIG. 11). These tags are relayed as input to the finite state automaton generated from the second representation (the secondary state machine).

Matches identified by the secondary state machine correspond to matches of the semantic requirements embodied in the second representation. The semantics embodied by the secondary state machine define a formal language that is a superset of the formal language specified by the original regular expression. It is understood by those skilled in the art that division of the matching process into a two level system loses a small amount of information embodied in the original regular expression, consequently loosening the semantic requirements for matching and thus increasing the size of the formal language.

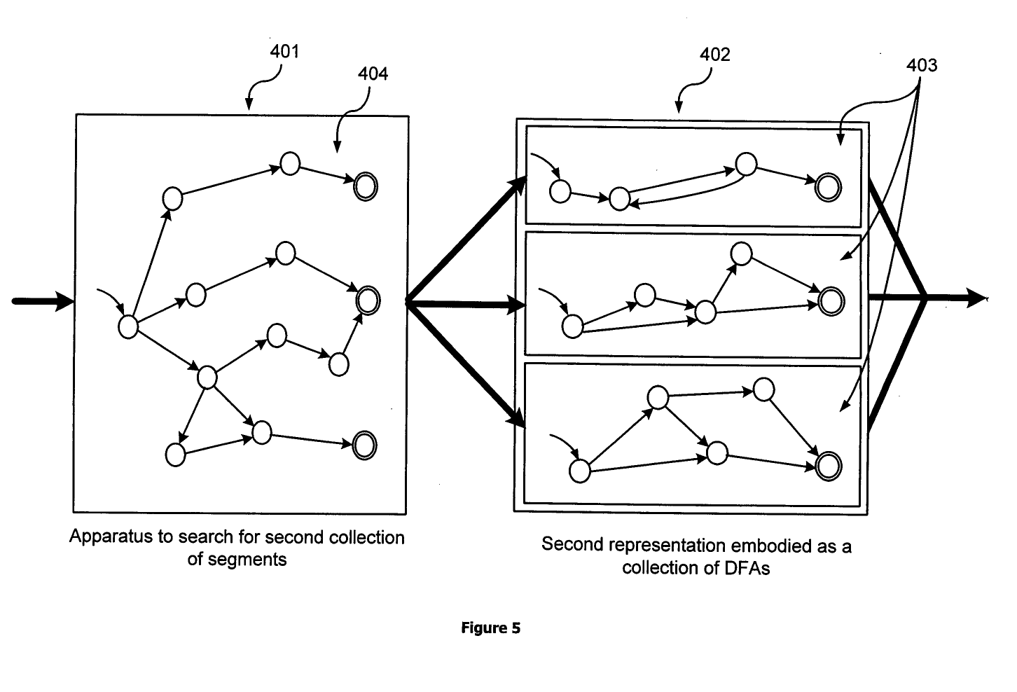

Another embodiment of the invention generates configuration information for the multi-level pattern matching apparatus depicted in FIG. 5. The destination apparatus depicted in FIG. 5 is similar to that depicted in FIG. 4 in that it comprises a two level hierarchy of pattern matching apparatuses, the lowest of which [401] comprises a single DFA [404] for matching the second collection of segments generated by the method of the invention. To generate configuration information for said destination apparatus the method of the invention proceeds in a manner similar to that explained above, with respect to the apparatus of FIG. 4. The destination apparatus depicted in FIG. 5 differs from that depicted in FIG. 4 in the embodiment of second representation generated by the method of the invention.

The configuration information generated by this embodiment of the method of the invention for the destination apparatus of FIG. 5 includes a second representation in the form of a collection of DFAs [403]. Said DFAs take as input the unique identifiers generated as match events by the low level matching apparatus [401], each DFA being configured to correctly handle any identifier that may be generated by the low level apparatus. These DFAs are incorporated into a high level matching apparatus [402] that distributes incoming events to all of the constituent DFAs and collects match events generated by any of said DFAs. Match events so generated are made visible to external systems and constitute the output of the entire apparatus as depicted in FIG. 5.

In two further embodiments of the invention the configuration information generated by the method of the invention is for an apparatus in which the generated second collection of segments is matched by a set of DFAs. The output of these DFAs is then used as input to a single DFA or a set of DFAs that embody the second representation generated, by the method of the invention, from the original plurality of regular expressions.

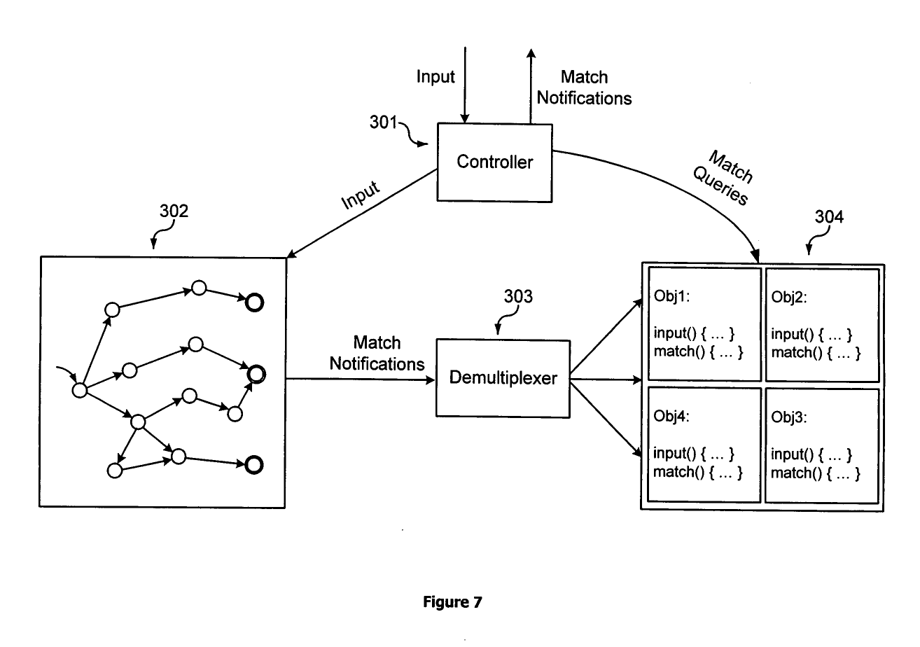

A further embodiment of the method of the invention generates configuration information for a hierarchical pattern matching apparatus in which the second representation is a set of pattern matching objects. FIG. 7 depicts such a destination apparatus. In this embodiment of the invention a second collection of segments is generated in the same manner as previously described embodiments and is similarly embodied as configuration for a conventional pattern matching sub-apparatus in the form of a DFA [302], or in alternate embodiment, as a set of DFAs. The output of said sub-apparatus [302] is transmitted to a collection of pattern matching objects through a demultiplexer object [303] that is configured to identify the correct destination object from the identifier in the match notification through the use of a lookup table or other means well understood by those of skill in the art. This collection of pattern matching objects is the second representation generated by the method of the invention.

The individual objects that comprise the object set [304] each have at least two message handling predicates with the following semantics. The input [symbol] predicate is used to receive match notifications generated by the low level matching architecture [302] and dispatched to the object via the demultiplexer [303]. It is through this predicate that the object implements the semantics of the second representation that it is designed to match. The second requisite predicate is the query predicate, match [symbol] , that is used to find the current state of the object, in particular with respect to whether the embodied representation has been matched, although the embodiment of partial matches, counted matches and other similar semantic constructs are within the scope of this invention. In most embodiments the invention will generate a second representation that configures a collection of objects that keep a record of where in the input stream matches have occurred, to allow the overall apparatus to report useful information regarding match location. This facility relies on the low level architecture [302] to report the input location when generating events.

The operation of the low level and high level pattern matching architectures is coordinated by the controller component [301]. This component receives an input stream from an external source, passes this input stream on to the low level component [302] and at an appropriate time, determined by the implementation semantics of the controller component, queries the constituent objects of the high level architecture [304] to identify the occurrence of any matches. After performing said object queries the controller [301] reports match notifications to any interested external system.

The abovementioned embodiments of the method of invention are each extended to accommodate input regular expressions that include actions tags. Action tagged regular expressions have numerical event identifiers associated with specific locations in the regular expression. The method of the invention is extended so that the generated second representation includes details of the action tags present in the input regular expressions. This allows the same action identifiers to be generated as output from the high level pattern matching architecture as would be generated from a single level implementation of the action tagged input regular expressions in an extension of a conventional pattern matching architecture.

All of the abovementioned embodiments of the method of the invention are extended with a number of variations of the method for producing the second collection of segments. Several variants retain the concept of splitting the original regular expressions through the removal of substrings known as split candidates. These split candidates are identified by a number of means. The simplest means, as used in the above described embodiments is the matching of substrings to a table of candidate literals. Such candidates include the above used example “.*”.

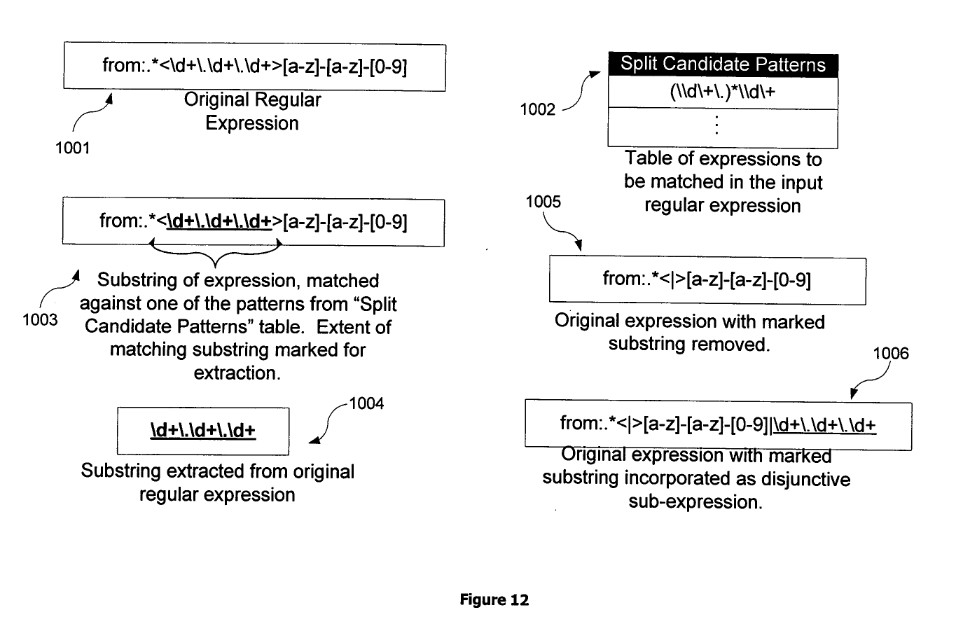

In further embodiments the identification of split candidates is performed using a pattern matching architecture configured with a set of candidate patterns. FIG. 12 depicts the operation of such an embodiment of the invention. The invention is configured with a table of patterns that are used to identify split candidates [1002]. The input regular expressions [1001] are searched for occurrences of patterns in this table. When any of said patterns is matched in an input regular expression by the method of the invention the extent of the match is tagged and such tagged sub-pattern is denoted as a split candidate [1003]. The invention the proceeds in the same manner as when identifying split candidates by table lookup; the tagged split candidate is removed from the expression [1004] and the resultant sub-patterns form the second collection of segments. [1005]. In an alternative of this embodiment of the invention the tagged split candidate is incorporated in the second collection [1006].

All of the abovementioned embodiments of the invention can be extended to include recursive application of the basic method of the invention. In the simplest embodiments, as taught above, the input expression is divided in a single pass. More complex embodiments of the method of the invention apply the procedure recursively, the resultant segment collection of one application of the process being subjected to a further application of the process and so on. The recursive application of the process can lead to representations embodying the high level semantics of the input regular expression that necessitate the use of the finite state machine model, or the pattern matching object model for the high level pattern matching architecture.

Still further embodiments of the invention use worst case analysis of the number of states required in a DFA representation of the second generated collection of segments. In these embodiments, a heuristic is used to estimate the number of states required to represents segments of the input expression. When a segment is estimated to exceed some predefined threshold the segment is divided into disjoint component segments. This method proceeds by applying the heuristic analysis recursively to the generated collection of segments until no further division is required. The accompanying second representation implied by this division method requires that the high level matching apparatus be implemented as a finite state machine or collection of objects.

In various embodiments of the invention the above described worst case analysis can be performed with a restriction on the total number of states required for any individual DFA representation of a generated segment or, in alternative embodiments, with a restriction on the total number of states required by the combination of all such generated DFAs or the total number of states required by a combined DFA matching all generated segments. In addition, in further embodiments of the invention the worst case analysis relies on the amount of memory used for a proprietary representation of the DFA, for example a compressed state table representation as described in published U.S. application No. US2005/0028114 A1, entitled “Efficient Representation of State Transition Tables”, and published U.S. application No. US2005/0035784 A1, entitled “Apparatus and Method for Large Hardware Finite State Machine with Embedded Equivalence Classes”, both commonly owned, the contents of both of which are incorporated herein by reference in their entirety. As is known to those skilled in the art, the concept of “top level” expression requires parsing of regular expressions and refers to whole expressions separated by use of the disjunctive operator “|” that do not occur within parenthesized sub-expressions.

FIG. 11 depicts the operation of the method of the invention for the destination apparatus depicted in FIG. 6. In the depicted example of the operation of the invention the input expression [601]:

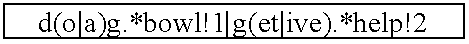

is converted into two DFAs. The invention produces a second collection of segments by dividing the first generated form of the input regular expression at the occurrence of features of little significance—in this case the occurrences of the idiom “.*”—and thus identifies the following second collection of segments:

| Identified Low Level | Assigned Action |
|---|---|
| Features | Tage |
| dag | 100 |
| dog | 200 |
| bowl | 300 |
| get | 400 |
| give | 500 |
| help | 600 |

The method of the invention converts these segments into a form suitable for the destination apparatus; in this case a single combined DFA [604]. It is understood that for simplicity DFA [602] is depicted in a simplified form that only includes significant transitions. It is further understood that other DFAs generated by the invention include more back transitions taken in the event of failed partial matches. This DFA has unique identifying tags associated with its terminal states. These tags are generated as output from the low level pattern matching apparatus [602] in the event of the DFA reaching one of these terminal states, i.e. when the DFA matches a low level feature in its input stream.

The method of the invention also generates a second representation in the form of DFA [605], this DFA being configuration for the high level pattern matching architecture component of the destination apparatus [603]. This DFA takes as input the output of the low level DFA [602], i.e., the action tags assigned to the identified low level features. The high level DFA [605] has its terminal states labeled with appropriate action tags from the input regular expression. These action tags are generated as output from the high level pattern matching architecture [603] in the event of the DFA reaching one of these terminal states, i.e., when the overall apparatus matches a sequence of segments that corresponds to a match of the input regular expression. The output of the high level pattern matching architecture [603] is revealed as the output of the whole apparatus and constitutes the pattern matching result.

The above embodiments of the present invention are illustrative and not limiting. Various alternatives and equivalents are possible. Other additions, subtractions or modifications are obvious in view of the present disclosure and are intended to fall within the scope of the appended claims.

What is claimed is:

1. A method for transforming a first regular expression, the method comprising:
converting the first regular expression into a first form;
segmenting the first form into a first collection and a first representation, the first collection comprising two or more segments from the first form, the first representation comprising data representing relationships between the two or more segments in the first collection, the first representation and first collection together defining a first language used to describe the first regular expression;
deriving a second collection of segments from the first collection;
deriving a second representation from the first representation and second collection of segments such that a second language defined by the second representation and the second collection is an approximation of the first language; and
creating a second form comprising the second representation and second collection, the second form representing the transformed first regular expression.

2. The method of claim 1 wherein the first form is a string representation of the first regular expression.

3. The method of claim 1 wherein the first form is a parse tree representation of the first regular expression.

4. The method of claim 1 wherein the first form is a first automaton, the first automaton is a finite state automaton representation of the first regular expression.

5. The method of claim 1 wherein sub-expressions in the first regular expression are tagged with one or more identifiers, and the first and second representations retain the semantics embodied by the tagging of sub-expressions of the first regular expression.

6. The method of claim 2 wherein the segments in the first collection are substrings of the first regular expression.

7. The method of claim 3 wherein the segments in the first collection are sub-trees of the parse tree representation of the first regular expression.

8. The method of claim 4 wherein the segments in the first collection are portions of the first automaton.

9. The method of claim 1 wherein the set of segments in the second collection is a subset of the set of segments in the first collection.

10. The method of claim 1 wherein the adequacy of the approximation is determined by the requirement that the formal language embodied by the second form is a superset of the formal language embodied in the first regular expression.

11. The method of claim 1 wherein the adequacy of the approximation is determined by the requirement that the formal language embodied by the second form is a subset of the formal language embodied in the first regular expression.

12. The method of claim 1 wherein the adequacy of the approximation is determined by the requirement that the formal language embodied by the second form is the same as the formal language embodied in the first regular expression.

13. The method of claim 2 wherein the method of segmenting the first form comprises:
locating one or more key segments in the first form, the one or more key segments being substrings of the first regular expression;
extracting the one or more key segments, the extracted one or more key segments belonging to the set of segments from the first form; and
extracting substrings of the first regular expression that have not been identified as key segments, the extracted substrings belonging to the set of segments from the first form.

14. The method of claim 13 wherein the substrings corresponding to the one or more key segments are found by the literal matching of substrings of the first regular expression against a table of candidate substrings.

15. The method of claim 13 wherein the substrings corresponding to the one or more key segments are found by the matching of substrings of the first regular expression against a table of regular expressions.

16. The method of claim 4 wherein the method of segmenting the first form comprises:
locating one or more key segments in the first form, the one or more key segments are portions of the first automaton;
extracting the one or more key segments, the extracted one or more key segments belonging to the set of segments from the first form; and
extracting portions of the first automaton that have not been identified as key segments, the extracted portions belonging to the set of segments from the first form.

17. The method of claim 16 wherein the portions of the first automaton corresponding to the one or more key segments are found heuristically based on the optimization of one or more cost functions, the cost functions comprising input variables that include properties of the first automaton.

18. The method of claim 1 further comprising a first process of producing new segmentations and representations iteratively until one or more requirements are met, the first process includes the operations of measuring, performing predictive calculations, and carrying out heuristic estimations.

19. The method of claim 18 wherein the first process operates until the combined size of DFAs representing the various segments crosses one or more thresholds.

20. The method of claim 18 wherein the first process operates until the number of states required to represent any of the various segments crosses one or more thresholds.

21. The method of claim 18 wherein the first process operates until the maximum length of any individual segment crosses one or more thresholds.

22. The method of claim 18 wherein the one or more requirements are determined with respect to the resources available on a hardware device.

23. The method of claim 1 wherein the second representation is a finite state automaton.

24. The method of claim 5 wherein the second form is used for matching patterns in a first stream of input data comprising the steps of:
sending a first stream of input data to one or more pattern matching systems, a second form loaded into the one or more pattern matching systems;
receiving pattern matching events from the one or more pattern matching systems, the pattern matching events include information on the tags in the second representation that matched one or more parts of the first input data stream, the tags in the second representation contain information on the corresponding sub-expression tags of the first regular expression; and
verifying that the first regular expression matches one or more parts of the first input data stream by examining the sub-expression tags of the first regular expression and the corresponding tags in the second representation that have been included in the pattern matching events returned by the one or more pattern matching systems.

25. The method of claim 24 further comprising performing one or more actions based on the results obtained from verifying whether the first regular expression matches one or more parts of the first input data.

26. The method of claim 25 wherein the one or more actions include storing and accumulating the match results.

27. The method of claim 25 wherein the one or more actions include ignoring one or more match results.

28. The method of claim 6 wherein the sub-expressions in the resulting second collection are converted to one or more finite automata.

29. The method of claim 28 wherein the one or more finite automata include a collection of deterministic finite automata.

30. The method of claim 28 wherein the one or more finite automata include a single combined deterministic finite automaton.

31. The method of claim 28 wherein the one or more finite automata include a collection of non-deterministic finite automata.

32. The method of claim 28 wherein the one or more finite automata include a single combined non-deterministic finite automaton.

33. An apparatus configured to transform regular expressions, the apparatus comprising:
a module adapted to convert a first regular expression into a first form;
a module adapted to segment the first form into a first collection and a first representation, the first collection comprising two or more segments from the first form, the first representation comprising data representing relationships between the two or more segments in the first collection, the first representation and first collection together defining a first language used to describe the first regular expression;
a module adapted to derive a second collection of segments from the first collection;
a module adapted to derive a second representation from the first representation and second collection of segments such that a second language defined by the second representation and the second collection is an approximation of the first language; and
a module adapted to create a second form comprising the second representation and second collection, the second form representing the transformed first regular expression.

34. The apparatus of claim 33 wherein the first form is a string representation of the first regular expression.

35. The apparatus of claim 34 wherein the module adapted to segment the first form further comprises:
a module adapted to locate one or more key segments in the first form, the one or more key segments being substrings of the first regular expression;
a module adapted to extract the one or more key segments, the extracted one or more key segments belonging to the set of segments from the first form; and
a module adapted to extract substrings of the first regular expression that have not been identified as key segments, the extracted substrings belonging to the set of segments from the first form.

36. The apparatus of claim 33 wherein the first form is a first automaton, the first automaton is a finite state automaton representation of the first regular expression.

37. The apparatus of claim 36 wherein the module adapted to segment the first form further comprises:
a module adapted to locate one or more key segments in the first form, the one or more key segments are portions of the first automaton;
a module adapted to extract the one or more key segments, the extracted one or more key segments belonging to the set of segments from the first form; and
a module adapted to extract portions of the first automaton that have not been identified as key segments, the extracted portions belonging to the set of segments from the first form.

38. The apparatus of claim 33 wherein sub-expressions in the first regular expression are tagged with one or more identifiers, and the first and second representations retain the semantics embodied by the tagging of sub-expressions of the first regular expression.

39. The apparatus of claim 38 wherein the second form is used for matching patterns in a first stream of input data, the apparatus further comprising:
a module adapted to send a first stream of input data to one or more pattern matching systems, a second form loaded into the one or more pattern matching systems;
a module adapted to receive pattern matching events from the one or more pattern matching systems, the pattern matching events include information on the tags in the second representation that matched one or more parts of the first input data stream, the tags in the second representation contain information on the corresponding sub-expression tags of the first regular expression; and
a module adapted to verify that the first regular expression matches one or more parts of the first input data stream by examining the sub-expression tags of the first regular expression and the corresponding tags in the second representation that have been included in the pattern matching events returned by the one or more pattern matching systems.
